(19) United States
(12) Patent Application Publication
(10) Pub. No.: US 2026/0342103 A1
(43) Pub. Date: Oct. 29, 2026

(54) CHARGING DEVICE AND METHOD FOR OPERATING THE CHARGING DEVICE

(71) Applicant: Robert Bosch GmbH, Stuttgart (DE)

(72) Inventors: Lukas Wieditz, Achern (DE); Vladimir Belau, Illingen (DE)

(21) Appl. No.: 19/110,758

(22) PCT Filed: Aug. 9, 2023
(86) PCT No.: PCT/EP2023/072024

§ 371 Date: Mar. 11, 2025

(30) Foreign Application Priority Data
Sep. 30, 2022 (DE) 10 2022 210 388.2

(51) Int. Cl. H02J 7/06; B60L 50/60; B60L 53/22; H02M 1/42; H02M 7/217

(52) U.S. Cl. CPC H02J 7/06; B60L 53/22; H02M 1/4208; H02M 7/217; B60L 50/60; H02J 2207/20

(57) ABSTRACT

Charging device for a vehicle, wherein the input side of the charging device (500) comprises an input terminal unit (100) for connecting a multiphase alternating voltage and a PFC stage (200) for providing a direct voltage at an intermediate terminal (300), wherein a second connecting line (120) is divided into a first part of the second connecting line (120_1) and into a second part of the second connecting line (120_2), wherein a second switching element (S2) is provided, which is arranged between the first part of the second connecting line (120_1) and the second part of the second connecting line (120_2), and is configured to conduct a charging current from the second input terminal (L2) via the first part and the second part of the second connecting line (120_1, 120_2) to the second throttle (204) or to conduct a charging current from the first connecting line (110) via the second part of the second connecting line (120_2) to the second throttle (204).

### BACKGROUND

The invention relates to a charging device and a method for operating the charging device. Furthermore, the invention relates to a drive train with a charging device, a vehicle with a drive train as well as a computer program and a computer-readable storage medium.

Charging devices, for example in vehicles with an electric drive in an electric vehicle or a hybrid vehicle, are used to recharge batteries, preferably accumulators or traction batteries, from an electrical energy source, preferably an external alternating voltage source or the public alternating voltage power supply. To this end, the charging device converts a sinusoidal alternating voltage current of the external power source to a direct voltage current. In a single-phase alternating voltage current, the power pulses at the double frequency of the alternating voltage current.

Preferably, charging devices have two-stage power electronics. A first stage, the so-called power-factor-correction stage, the PFC stage, converts the sinusoidal input voltage from the alternating voltage power grid into a direct voltage. A second stage consists of a direct voltage converter or DC/DC converter that ensures galvanic isolation via a transformer and adjusts the voltage levels. Preferably, the output voltage and/or the output current for charging the battery is adjusted by means of an electric circuit and a controller. An intermediate capacitor is arranged between the two stages, which buffers the power pulsation in the double frequency of the alternating voltage current of the power source. Typically, this intermediate circuit is realized by at least one electrolyte capacitor. These topologies allow for the maintenance of a near sinusoidal input current on the power grid side to meet power grid-side standards, a galvanic isolation between the power grid and vehicle to meet safety requirements, and a constant direct voltage output current on the side of the battery to minimize the load on the battery during charging.

In an electric drive vehicle, the battery is further connected to an inverter to supply energy to the electric drive machine. A direct voltage converter is connected in parallel to the inverter to supply a low-voltage network, or an on-board power supply, of the vehicle to supply the control units with energy. At the beginning of the charging process, the charging device is connected via the one PFC stage to the sinusoidal input voltage from the alternating voltage network or the AC low-voltage network. The PFC stage is connected or switched in on the output side to the intermediate capacitor, which is part of an intermediate voltage circuit. The intermediate voltage circuit is discharged when connected to the AC low-voltage network. Due to its low impedance, when the AC low-voltage network is switched on, a high input current results that charges the intermediate voltage circuit. In order to avoid power grid-side faults or the destruction of components of the power electronics, for example, fuses releasing due to excess current, this input current must be limited. One wide-spread implementation for input current limitation is the limitation via pre-charging resistors in the connecting lines between the alternating voltage power system and the PFC stage, which are bridged via relays during normal operation. A corresponding input current must be limited in each connecting line of the PFC stage. This requires a variety of pre-charging resistors and relays. Therefore, there is a need for a simple and compact solution that allows for charging of the intermediate capacitor with fewer components.

### SUMMARY

A charging device is provided for a vehicle, wherein the input side of the charging device comprises a multiphase, n-phase input terminal unit, wherein n is an integer greater than 1, preferably three-phase, input terminal unit for connecting an n-phase alternating voltage and a PFC stage for providing a direct voltage at a bipolar intermediate terminal. The intermediate terminal comprises a positive intermediate terminal and a negative intermediate terminal. The PFC stage comprises an nth half-bridge per phase of the n-phases. A half-bridge each comprises a series connection with a high-side switch and a low-side switch. In each case, a center pickup between the high-side switch and the low-side switch of a half-bridge can be connected via a throttle to a one of the n input terminals of the n-phase input terminal unit via an nth connecting line in each case. Thus, for example, the center pickup of the first half-bridge can be connected to the first input terminal via the first throttle via the first connecting line. Thus, for example, the center pickup of the second half-bridge can be connected to the second input terminal via the second throttle via the second connecting line, etc. The n-half-bridges are connected in parallel and their ends are connected to the bipolar intermediate terminal. The high side switches are connected to a positive intermediate terminal and the low side switches are connected to a negative intermediate terminal of the bipolar intermediate terminal. An intermediate capacitor is connected between the positive intermediate terminal and the negative intermediate terminal. This intermediate capacitor is part of the intermediate voltage circuit. The second connecting line is divided into a first part of the second connecting line and a second part of the second connecting line. A second switching element is provided, which is arranged between the first part of the second connecting line and the second part of the second connecting line, and is configured to conduct a charging current from the second input terminal via the first part and the second part of the second connecting line to the second throttle, or to conduct a charging current from the first connecting line to the second throttle via the second part of the second connecting line. A second switching element, preferably a second changeover contact, is arranged between a first part of the second connecting line and a second part of the second connecting line. Depending on the switch position of the second switching element, a charging current is thus conducted from the second input terminal via the first part and the second part of the second connecting line to the second throttle or a charging current is conducted from the first connecting line via the second part of the second connecting line to the second throttle.

Advantageously, a circuit for a charging device with a multiphase alternating voltage input is provided, where there is the possibility that an input current for charging the intermediate capacitor does not flow through all phases of the alternating voltage input. Advantageously, the second switching element can be used to decouple the first part of the second connecting line from the PFC stage and thus from the intermediate capacitor. Preferably, the first part of the second connecting line is only connected to the PFC stage after the intermediate capacitor has been charged. Preferably, an inrush current is thus prevented when the first part of the second connecting line is switched on. Advantageously, a pre-charging resistor, preferably with a bypass switching element, is not required between the second input terminal and the first part of the second connecting line. Preferably, due to the configuration of the second switching element as a second converter, a short circuit between the first connecting line and the first part of the second connecting line is prevented. Preferably, a short circuit between the first input terminal and the second input terminal would be possible by means of a faultily actuated simple switching element. By means of the second converter, this error case can be reliably ruled out when it is controlled. In addition to the first and second phases of a PFC stage, a switching element corresponding to the second switching element and its arrangement is also preferably installed in other phases in order to dispense with a pre-charging resistor in the other phases as well.

An external power source is preferably a multiphase, preferably a three-phase alternating voltage power system, preferably the low-voltage public power grid. Preferably, in a North American region or Japanese region, this is a 120 or 240 volt single-phase alternating voltage network. Preferably, in a Chinese or European region, this is a three phase alternating voltage power system of about 230 Volts. For charging operation of the charging device, the charging device is preferably connected to a corresponding alternating voltage power supply via the n-phase input terminal unit or connected to the corresponding alternating voltage. Preferably, the n-phase input terminal unit comprises a neutral terminal for connecting a neutral conductor of the alternating voltage power system to be connected. Preferably, a battery to be charged is an accumulator or a traction battery by means of which energy is supplied to an electric drive train of a vehicle. A rectification circuit is preferably a rectifier for converting the alternating voltage current into a direct voltage current. A high side switch or a low side switch of a semiconductor bridge is preferably a power semiconductor switch comprising an intrinsic diode, preferably an IGBT or MOSFET, preferably based on Si, SiC or GaN technology. Preferably, the expression connecting, for example, a center pickup to a connecting line, means contacting or connecting the components by means of an electrically conductive line or a galvanic connection. The expression blocking, preventing, decoupling or preventing a current flow means disconnecting an electrically conductive line or connection. Preferably, the expression switched is used synonymously with electrically connected, wherein switchably connected means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In one embodiment, to charge the intermediate capacitor before the start of a charging process, the second switching element is actuated such that a charging current is conducted from the first connecting line to the second throttle via the second part of the second connecting line. Consequently, a current flow between the first part of the second connecting line and the second part of the second connecting line is preferably prevented.

Advantageously, an actuation of the second switching element is provided, which prevents a current flow via a first part of the second connection line to the second part of the connection line when charging the intermediate capacitor. As a result, there is no high inrush current through the second phase of the input terminal unit for connecting the multiphase alternating voltage.

In one embodiment, the intermediate capacitor is charged until the voltage at the intermediate capacitor corresponds to or exceeds a predeterminable voltage value.

The second switching element for charging the intermediate capacitor is actuated until the voltage at the intermediate capacitor corresponds to or exceeds a predeterminable voltage value. For this purpose, the voltage at the intermediate capacitor is determined by means of a detection unit or a measuring device and compared with the predeterminable voltage value. This predeterminable voltage value is predetermined or corresponds to the voltage applied to at least one of the input terminals. To determine the predeterminable value, the voltage at the second input terminal is preferably determined by means of a suitable determination unit or measuring device and preferably specified as a voltage value depending on the magnitude of the maximum amplitude. Alternatively, the voltage value is preferably predetermined as a function of the connected alternating voltage or the region in which the charging device is operated, or preferably read and predetermined from a characteristic diagram.

Alternatively, in another embodiment, the intermediate capacitor is charged until the alternating voltage current through the first and/or second connecting line or through the first connecting line and/or at least the second part of the second connecting line falls below a predeterminable alternating voltage current value. Preferably, the predeterminable alternating voltage current value is approximately 100 mA. Preferably, the predeterminable alternating voltage current value is set so low that no overcurrent occurs when the second switching element is subsequently actuated such that a charging current is conducted from the second input terminal via the second connecting line, via the first part of the second connecting line and via the second part of the second connecting line to the second throttle. Preferably, the alternating voltage current is determined for this purpose during charging of the intermediate capacitor by means of an alternating voltage current measuring device. The alternating voltage current measuring unit is preferably arranged between the first input terminal and the intermediate terminal and/or between the second input terminal and the intermediate terminal.

Advantageously, a controller is provided for the charging device that prevents a high input current through the second phases of the input terminal unit to connect the multiphase alternating voltage.

In another embodiment, in order to provide electrical energy at the intermediate terminal for a charging process, an alternating voltage supplied to the input terminal unit is provided via the PFC stage at least partially as direct voltage at the positive intermediate terminal and at the negative intermediate terminal, wherein the second switching element is actuated such that a charging current is conducted via at least the first connecting line and the second connecting line, or via at least the first connecting line and at least the second part of the second connecting line, and via the PFC stage to the intermediate terminal.

In a charging process, the charging device converts the electrical energy provided to the input terminal unit, the alternating voltage provided or the alternating voltage current provided, into a charging voltage for charging a battery, preferably for charging a vehicle battery. The charging device is designed in two stages for this purpose. By means of the first stage, the PFC stage, the sinusoidal input voltage from the alternating voltage network is converted into a direct voltage in the intermediate voltage circuit. By means of the second stage, a downstream direct voltage converter, which preferably ensures galvanic isolation via a transformer, the voltage levels are adjusted and the charging voltage and the charging current for charging the battery are provided on the output side by means of a circuit and a controller. In the case of a single-phase alternating voltage, the second switching element is preferably actuated such that a charging current is conducted via at least the first connecting line and at least the second part of the second connecting line and via the PFC stage to the intermediate terminal. Preferably, the charging current is distributed over two phases within the PFC stage, thus reducing the load on the electronic components. Advantageously, the charging device can be operated in single-phase mode with a higher charging current than in multiphase mode. In the case of a two-phase or multiphase alternating voltage supply, the second switching element is preferably actuated such that a charging current is conducted both via at least the first connecting line and also the second connecting line and via the PFC stage to the intermediate terminal. Preferably, the charging current from the alternating voltage network for each phase is conducted directly via the PFC stage to the intermediate terminal.

Advantageously, a topology is provided that allows a direct voltage to be provided at the intermediate terminal for a charging process, wherein the power for this is provided by an external power source that provides a multiphase alternating voltage to the input terminal unit.

In another embodiment, a first switching element is provided and is configured to enable or interrupt a current flow between the first input terminal and the first connecting line through the first switching element.

A first switching element is arranged between the first connecting line and the first input terminal. A first switching element is provided and is configured to allow or interrupt a current flow between the first input terminal and the first connecting line or the first throttle of the PFC stage. Depending on the switch position, a current flow or a charging current from the first input terminal through the first switching element towards the first throttle of the PFC stage is thus enabled or prevented.

Advantageously, the first switching element provides a means of interrupting or switching on a charging current via the first connecting line through the first switching element. Preferably, a pre-charging resistor, preferably a PTC resistor, is connected in parallel with the first switching element, which is used to limit an inrush current. Preferably, the inrush current flows from the first input terminal via the pre-charging resistor via the PFC stage into the intermediate capacitor when the intermediate capacitor is being charged. The pre-charging resistor decreases the input current and thus prevents excess current. Preferably, to avoid losses in the pre-charging resistor, it is bridged by closing the first switching element when the intermediate capacitor is substantially charged.

In another embodiment, the intermediate capacitor is configured as a series connection consisting of a first capacitor and a second capacitor.

The intermediate capacitor is preferably configured as a series connection consisting of a first and a second capacitor. Preferably, the capacitance of the first capacitor and the second capacitor is equal. Preferably, a neutral conductor, preferably switchable, is connected at a center pickup between the first and second capacitors for connecting to a corresponding contact of the input terminal unit. Preferably, a neutral conductor for operating the charging device is provided with asymmetric loading. Preferably, an asymmetric load is present in the case of operation with a 2-phase network or also with an asymmetric load in the case of operation with a 3-phase network, i.e., two-phase or three-phase alternating voltage. In these cases, a balancing current flows via the neutral conductor back into the alternating voltage power system connected on the input side.

Advantageously, a suitable circuit topology for connecting a neutral conductor is provided.

In another configuration, a third switching element is provided and is configured to allow or interrupt a current flow between the third input terminal and the third connecting line or the third throttle of the PFC stage.

A third switching element is arranged between the third connecting line and the third input terminal. Depending on the switch position, a current flow or a charging current from the third input terminal towards the third throttle of the PFC stage is thus enabled or prevented. Advantageously, a possibility is created to interrupt or switch on a charging current, preferably in the presence of a three-phase charging current, via the third connecting line. A pre-charging resistor, preferably a PTC resistor, is preferably connected in parallel with the third switching element and is used to limit the inrush current. Preferably, the inrush current flows from the third input terminal via the PFC stage into the first and/or second capacitor. Preferably to avoid losses of the pre-charging resistor, this is bridged by closing the third switching element when the first and/or second capacitor is essentially charged.

Furthermore, the invention relates to a drive train of a vehicle with a charging device as described above, wherein the drive train comprises in particular a traction battery, an inverter and/or an electric machine. Advantageously, a drive train of an electric vehicle is provided with a charging device having a simplified circuit topology.

The invention further relates to a vehicle having a drive train, as described above.

Advantageously, a vehicle having a charging device with a simplified circuit topology is provided.

The invention further relates to a method for operating a charging device as presented above with the step of: Actuation of the second switching element, and preferably the first switching element, and the high-side and low-side switches of the half bridges to provide electrical energy at the bipolar intermediate terminal.

By actuating the second switching element, and preferably the first switching element, and the switches of the half bridges, the alternating voltage applied to the input terminal is first used to charge the intermediate capacitor and then permanently converted into a direct voltage to supply the connected direct voltage converter of the charging device to generate the charging voltage for the battery to be charged. Advantageously, a method is provided that enables a direct voltage to be provided on the intermediate voltage circuit.

The invention further relates to a computer program comprising commands which, when the program is executed by a computer, prompt the latter to perform the method described.

The invention furthermore relates to a computer-readable memory medium comprising commands which, when executed by a computer, prompt the latter to perform the method steps described above.

It is understood that the features, properties, and advantages of the charging device apply or can be applied accordingly to the method or the drive train and the vehicle and vice versa.

Further features and advantages of embodiments of the invention are apparent from the following description with reference to the accompanying drawings.

### BRIEF DESCRIPTION OF THE DRAWINGS

The invention will be explained in further detail hereinafter with reference to the drawings:

FIG. 1 a schematic representation of a prior art embodiment of a circuit topology for a charging device

FIG. 2 a schematic illustration of an embodiment of a circuit topology for a charging device,

FIG. 3 a schematic illustration of a vehicle comprising a drive train with a charging device,

FIG. 4 a schematic illustration of a flow chart for a method for operating a charging device.

### DETAILED DESCRIPTION

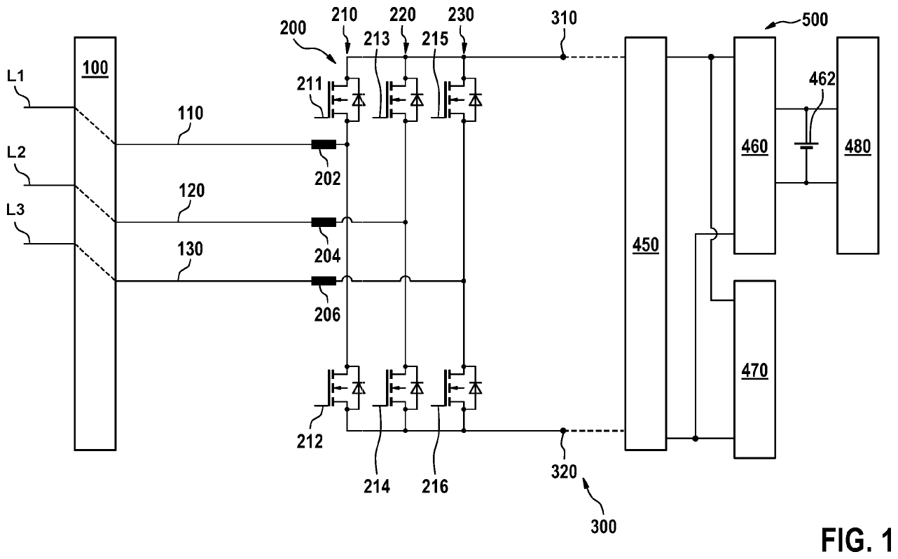

FIG. 1 shows a charging device 500, preferably for a vehicle. The charging device 500 comprises an input-side input terminal unit 100 for connecting a, for example, single-phase to three-phase alternating voltage and a PFC stage 200 for providing a direct voltage to an intermediate terminal 300. The PFC stage 200 of the charging device 500 includes a first 210, a second 220, and a third 230 half-bridge. The first, second, and third half-bridges 210, 220, 230 each include a series connection having a high-side switch 211, 213, 215 and a low-side switch 212, 214, 216. In each case, a center tap between the high side switch and the low side switch of a half-bridge can be connected via a first, second and third throttle 202, 204, 206 to a first, second and third input terminal L1, L2, L3 of the input terminal unit 100 via a first, second and third connecting line 110, 120, 130 in each case. Thus, the center pickup of the first half-bridge 210 can be connected via the first throttle 202 to the first input terminal LI via the first connecting line 110. Thus, the center pickup of the second half-bridge 220 can be connected via the second throttle 204 to the second input terminal L2 via the second connecting line 120. Thus, the center pickup of the third half-bridge 230 can be connected via the third throttle 206 to the third input terminal L3 via the third connecting line 130. The half-bridges 210, 220, 230 are connected in parallel. Their ends are connected to the bipolar intermediate terminal 300. The high-side switches are connected to a positive intermediate terminal 310 and the low-side switches are connected to a negative intermediate terminal 320. Preferably, a direct voltage converter 450 is connected to the intermediate terminal 300. The direct voltage at the intermediate terminal 300, which is applied to the input side of the direct voltage converter 450, is preferably converted into a charging voltage for charging a battery 470, preferably a traction battery or a high-voltage battery, which is connected to the output side of the direct voltage converter 450. Preferably, a further direct voltage converter 460, preferably a step-down converter, is connected in parallel with the battery 470 to convert the charging voltage into a low voltage for charging a low-voltage battery 462 and to supply an on-board power supply of a vehicle to supply control devices of a vehicle. The low-voltage battery 462, and preferably also further low-voltage loads 480, are connected to the vehicle's on-board power supply. Preferably, the further direct voltage converter 460 is a bidirectional direct voltage converter. Preferably, the further direct voltage converter 460 may be used to pre-charge the high-voltage intermediate circuit before the battery 470 is connected to the charging device 500. The high-voltage intermediate circuit is connected to the direct voltage converter 450 on the output side.

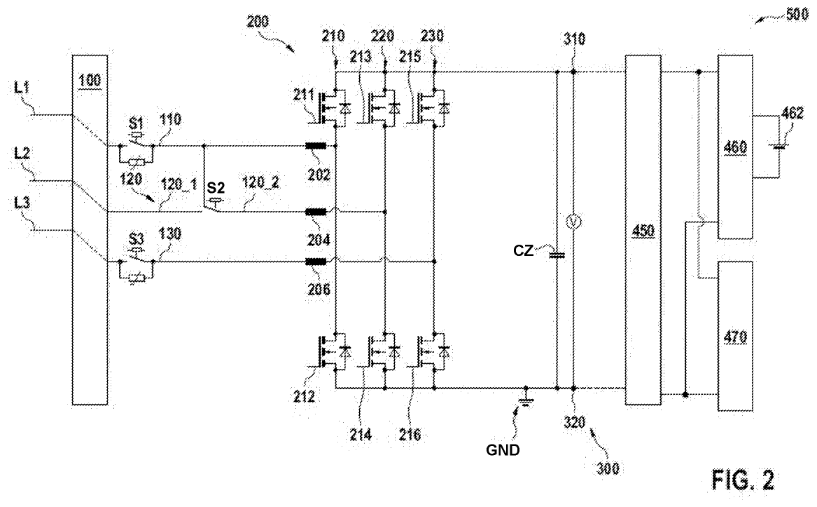

Based on the charger 500 according to FIG. 1, the charging device 500 according to the invention according to FIG. 2 comprises an n-phase input terminal unit 100 for connecting a multiphase AC voltage with n phases, wherein n is greater than 1. For example, a three-phase input terminal unit is shown for connecting a three-phase alternating voltage. The second connecting line 120 is divided into a first part of the second connecting line 120_1 and a second part of the second connecting line 120_2. A second switching element S2 is provided for this purpose, which is arranged between the first part of the second connecting line 120_1 and the second part of the second connecting line 120_2. The second switching element S2 is configured to conduct a charging current from the second input terminal L2 via the first part and the second part of the second connecting line 120_1, 120_2 to the second throttle 204 or to conduct a charging current from the first connecting line 110 via the second part of the second connecting line 120_2 to the second throttle 204. The second switching element S2 is preferably configured as a converter to implement this function. Preferably, a first switching element S1 is provided and is configured to allow or interrupt a current flow between the first input terminal L1 and the first connecting line 110. Preferably, a third switching element S3 is provided and is configured to allow or interrupt a charging current between the third input terminal L3 and the third connecting line 130. Pre-charging resistors, preferably switchable resistors, PTC thermistors or PTC resistors, are preferably connected in parallel with the first S1 and the third S3 switching element so that an inrush current is limited when an alternating voltage is connected to the input terminal unit 100 before the first and third switching elements S1, S3 are closed. An intermediate capacitor CZ is connected in parallel to the half-bridges 210, 220, 230. Preferably, the intermediate capacitor CZ is replaced by means of a series connection consisting of a first C1 and a second C2 capacitor (not shown). Preferably, a current sensor is arranged in series with each of the first, second and third throttles 202, 204, 206 (not shown) for determining the current through the respective throttle 202, 204, 206. Depending on the determined currents, preferably the high-side switches and the low-side switches as well as the switching elements are actuated to implement the desired operation modes. Preferably, a voltage sensor (V) is arranged between the positive and negative intermediate terminals 310, 320 to determine or measure the voltage at the intermediate capacitor. Depending on the determined voltages, preferably the high-side switch and the low-side switch as well as the switching elements are controlled to implement the desired operation modes. Preferably, the negative intermediate terminal 320 is connected to ground GND. Preferably, GND is an internal voltage potential. Preferably, the voltage at the intermediate capacitor is measured or determined between the positive intermediate terminal 310 and the negative intermediate terminal 320. Preferably, the voltage at the second input terminal is measured and determined versus a neutral terminal (not shown). Preferably, the switching elements are provided as semiconductor switch components (IGBT or MOSFETS, based on Si, SiC or GaN) or as contactors or relays.

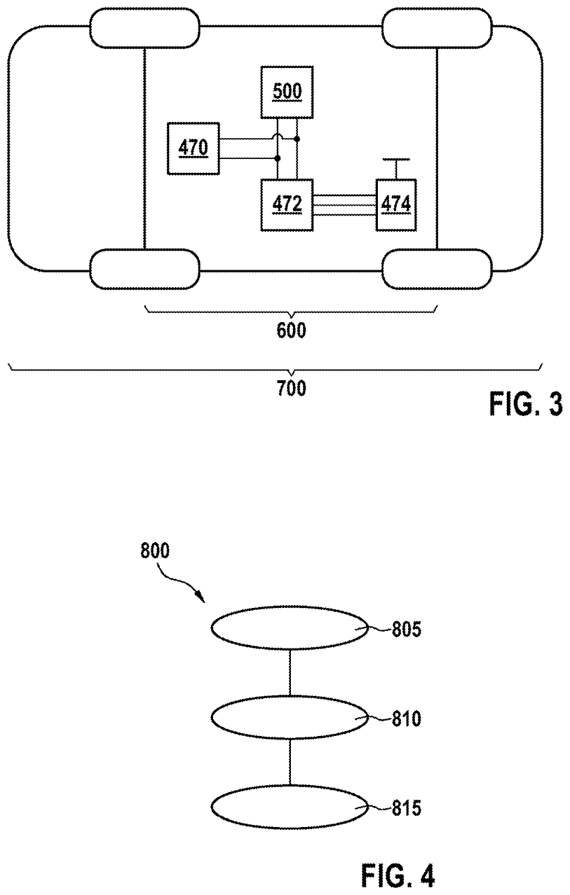

FIG. 3 shows a schematic illustration of a vehicle 700 comprising a drive train 600 with a charging device 500. The vehicle 700 is in this case shown (only by way of example) as comprising four wheels, wherein the invention can be used equally in any vehicle with any desired number of wheels on land, on water, and in the air. The exemplary drive train 600 shown includes at least one charging device 500. Furthermore, the drive train preferably comprises a battery 470, an inverter 472 and/or or an electric machine 474.

FIG. 4 shows a schematic flow chart for a method 800 for operating a charging device 500. The method 800 starts with step 805. In step 810, the second switching element S2, preferably the first switching element S1, and the high-side and low-side switches of the half bridges 210, 220, 230 are actuated to provide electrical energy at the intermediate capacitor CZ. The method ends at step 815.

1. A charging device for a vehicle, wherein an input side of the charging device (500) comprises an input terminal unit (100) for connecting a multiphase alternating voltage with n phases, wherein n is greater than or equal to 1, and a PFC stage (200) for providing a direct voltage at an intermediate terminal (300),
wherein the PFC stage (200) comprises a half-bridge (210, 220, 230) for each of the n phases, wherein each half-bridge (210, 220, 230) is connected in series to a high-side switch (211, 213, 215) and a low-side switch (212, 214, 216), wherein a center pickup between the high-side switch and the low-side switch of each half-bridge can be connected, via a throttle (202, 204, 206) to each of the n input terminals (L1, L2, L3) of the input terminal unit (100) through an nth connecting line (110, 120, 130),
wherein the n-half-bridges (210, 220, 230) are connected in parallel and their ends are connected to the bipolar intermediate terminal (300), wherein the high side switches are connected to a positive intermediate terminal (310) and the low side switches are connected to a negative intermediate terminal (320), wherein an intermediate capacitor (CZ) is connected between the positive intermediate terminal (310) and the negative intermediate terminal (320),
wherein
a second connecting line (120) is divided into a first part of the second connecting line (120_1) and a second part of the second connecting line (120_2), wherein a second switching element (S2) is provided, which is arranged between the first part of the second connecting line (120_1) and the second part of the second connecting line (120_2), and is configured to conduct a charging current from the second input terminal (L2) via the first part and the second part of the second connecting line (120_1, 120_2) to the second throttle (204) or to conduct a charging current from the first connecting line (110) to the second throttle (204) via the second part of the second connecting line (120_2).

2. The charging device according to claim 1,
wherein, for charging the intermediate capacitor (CZ) before the start of a charging process, the second switching element (S2) is actuated such that a charging current is conducted from the first connecting line (110) to the second throttle (204) via the second part of the second connecting line (120_2).

3. The charging device according to claim 2,
wherein the intermediate capacitor (CZ) is charged until the voltage at the intermediate capacitor (CZ) exceeds a predeterminable voltage value.

4. The charging device according to claim 1,
wherein an alternating voltage supplied to the input terminal unit (100) via the PFC stage (200) is provided at least in part as a direct voltage at the positive intermediate terminal (310) and the negative intermediate terminal (320), in order to provide electrical energy at the intermediate terminal (300) for a charging process,
wherein the second switching element (S2) is actuated such that a charging current is conducted via at least the first connecting line (110) and the second connecting line (120), or via at least the first connecting line (110) and at least the second part of the second connecting line (120_2), and via the PFC stage (200) to the intermediate terminal (300).

5. The charging device according to claim 1,
wherein a first switching element (S1) is provided and configured to enable or interrupt a current flow between the first input terminal (L1) and the first connecting line (110) through the first switching element (S1).

6. The charging device according to claim 1, wherein the intermediate capacitor (CZ) is configured as a series connection consisting of a first capacitor (C1) and a second capacitor (C2).

7. A drive train (600) of a vehicle (700) having a charging device (500) according to claim 1, wherein the drive train (600) comprises a traction battery (470), an inverter (472), and/or an electric machine (474).

8. A vehicle (700) having a drive train (600) according to claim 7.

9. A method (800) for operating a charging device, wherein an input side of the charging device (500) comprises an input terminal unit (100) for connecting a multiphase alternating voltage with n phases, wherein n is greater than or equal to 1, and a PFC stage (200) for providing a direct voltage at an intermediate terminal (300),
wherein the PFC stage (200) comprises a half-bridge (210, 220, 230) for each of the n phases, wherein each half-bridge (210, 220, 230) is connected in series to a high-side switch (211, 213, 215) and a low-side switch (212, 214, 216), wherein a center pickup between the high-side switch and the low-side switch of each half-bridge can be connected, via a throttle (202, 204, 206) to each of the n input terminals (L1, L2, L3) of the input terminal unit (100) through an nth connecting line (110, 120, 130),
wherein the n-half-bridges (210, 220, 230) are connected in parallel and their ends are connected to the bipolar intermediate terminal (300), wherein the high side switches are connected to a positive intermediate terminal (310) and the low side switches are connected to a negative intermediate terminal (320), wherein an intermediate capacitor (CZ) is connected between the positive intermediate terminal (310) and the negative intermediate terminal (320),
wherein a second connecting line (120) is divided into a first part of the second connecting line (120_1) and a second part of the second connecting line (120_2), wherein a second switching element (S2) is provided, which is arranged between the first part of the second connecting line (120_1) and the second part of the second connecting line (120_2), and is configured to conduct a charging current from the second input terminal (L2) via the first part and the second part of the second connecting line (120_1, 120_2) to the second throttle (204) or to conduct a charging current from the first connecting line (110) to the second throttle (204) via the second part of the second connecting line (120_2),
the comprising the following step:
controlling (810) the second switching element (S2) as well as the high-side and low-side switches of the half-bridges (210, 220, 230) for providing electrical energy at the intermediate capacitor (CZ).

10. (canceled)

11. A non-transitory, computer-readable storage medium comprising commands which, when executed by a computer, prompt the latter to perform the method (800) according to claim 9.
